(19) United States
(12) Patent Application Publication
(10) Pub. No.: US 2015/0136061 A1
(43) Pub. Date: May 21, 2015

(54) ENGINE CONTROL VALVE WITH IMPROVED OPERATION

(71) Applicant: Valeo Systemes de Controle Moteur, Cergy St Christophe (FR)

(72) Inventor: Gregory Hodebourg, Sartrouville (FR)

(21) Appl. No.: 14/411,924

(22) PCT Filed: Jul. 1, 2013
(86) PCT No.: PCT/FR2013/051537

§ 371 Date: Dec. 30, 2014

(30) Foreign Application Priority Data
Jul. 4, 2012 (FR) 1256392

(51) Int. Cl. F02M 25/07

(52) U.S. Cl. CPC F02M 25/0793
USPC 123/190.1

(57) ABSTRACT

The invention relates to an engine control valve including a body defining an inner duct and comprising a flap (10) mounted such that it can pivot by means of a shaft (12) of the flap (10), said flap (10) including a first portion (11). The flap can pivot between an open position allowing the passage of gas into the duct and a closed position in which the flap (10) comes into contact with a seal (1) that is solidly connected to the body of the flap. The outer contour of the seal (1) surrounds the outer contour of the flap (10), said seal (1) comprising an opening (6) and a solid portion (3). The above-mentioned first portion (11) seals the opening (6) in the seal (1) when the flap (10) is in a closed position. The flap (10) comprises a boss (18), separate from the first portion (11), which is positioned such as to remain in contact with the solid portion (3) of the seal (1) when the flap (10) pivots between an open position and a closed position or vice versa.

The invention relates to an engine control valve with improved operation. This type of valve may for example be fitted in a gas supply circuit of a vehicle combustion engine, in order to regulate the flow rate of the EGR (Exhaust Gas Recirculation) gases in a loop making it possible to bleed a part of the exhaust gases leaving the engine so as to reinject them upstream of said engine. The operating principle of this type of valve is based on the controlled rotation of a flap which can move from a completely open position for allowing the fluid to pass through to a closed position for blocking this passage. The subject of the invention is an engine control valve with improved operation.

An engine control valve thus has a flap which is mounted in a pivoting manner on a rotary pin. The flap may comprise a first part and a second part that are separated by the rotary pin. When this flap is in a closed position, it comes into contact with a gasket that is secured to the body of the valve, said gasket sealing the valve by acting as a positioning end stop for said flap. More specifically, the gasket is generally flat overall and is fastened in the body of the valve by being inserted at its perimeter between two cast elements of said body. The gasket has an opening, and when the flap is in the closed position, the first part of the flap comes into contact with one of the two faces of the gasket in order to close off said opening, while the second part of said flap is flush with the other face of said gasket. The flap has a small thickness and has a substantially rectangular overall shape.

At first, for reasons associated with its machining, the gasket only covered three of the four peripheral edges of said flap, leaving a potential passage for the gases at the fourth edge of the flap, which is not covered by said gasket. Thus, when the flap is in the closed position against the gasket, said passage is likely to favor an accidental leak of the gases. This results in fairly mediocre sealing of said valve in the closed configuration.

Then, a solution for remedying this poor-quality sealing consisted in the manufacture of a gasket either in one part or in two parts, said gasket being sufficiently extensive to fully cover the four peripheral edges of the flap and thus to limit the sources of leaks.

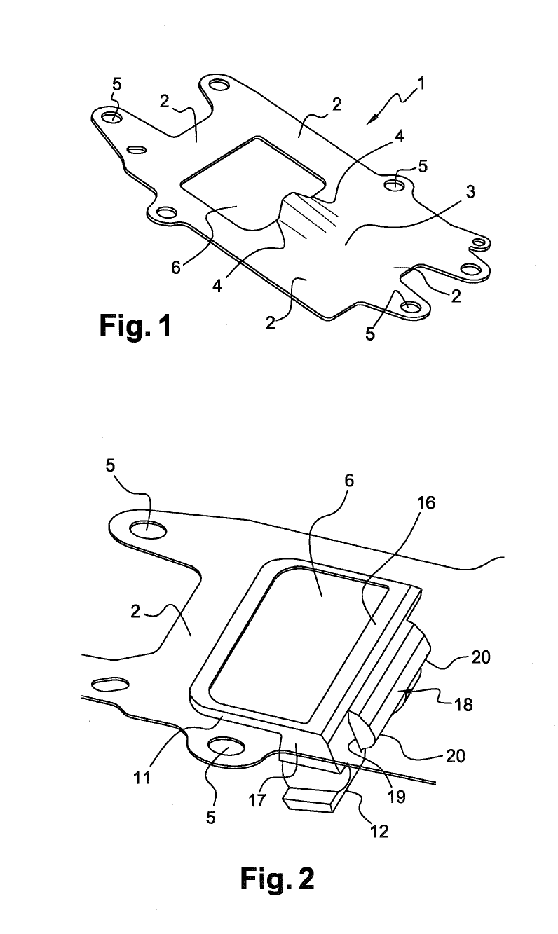

However, with reference to FIG. 1, a problem that is regularly encountered with this type of extensive gasket 1 is that it is subjected both to a high pressure and to a high temperature by the gases present in the valve and it thus tends to deform under the effect of thermal expansion. Since said gasket is inserted at its outer edge 2 between two cast elements, the deformation will essentially occur in the central part 3 of the gasket 1, creating hollows 4 and/or bosses which are likely to form leakage passages for the gases located in the valve. Moreover, in the case where the gasket 1 deforms and creates hollows 4, it risks forming an artificial blocking stop for the flap, and thus impeding the pivoting thereof in order to come into contact with said gasket 1 in order to close the valve. In other words, the deformation of the gasket risks impeding the operating mechanism of the valve.

The application DE 197 18 862 discloses a valve with a pivoting flap having a rounded end portion that is able to close off an opening in a gasket when the valve is closed by bearing against the gasket.

The subject of the invention, according to one of its aspects, is an engine control valve having a body that delimits an internal duct and comprising a flap mounted in a pivoting manner by way of a pin of the flap, the flap comprising a first part, said flap being able to pivot between an open position allowing gas to pass through the duct and a closed position in which the flap comes into contact with a gasket, notably a flat gasket, secured to the body of the valve, said gasket having an external contour that externally surrounds the external contour of the flap, the gasket comprising an opening and a solid portion, said first part closing off the opening in the gasket when the flap is in a closed position, the flap comprising a bulge positioned so as to remain in contact with the solid portion of the gasket when the flap pivots between an open position and a closed position or vice versa.

The bulge may be separate from the first part of the flap, that is to say that the bulge does not close off the opening in the gasket when the flap is in the closed position, this closing off being brought about by the first part of the flap.

The bulge is advantageously positioned on the flap so as to act as a support for the solid portion of the gasket. Specifically, the gasket is generally inserted at its peripheral edge between two cast elements of the body of the valve. The central part of the gasket thus forms a region of structural weakness that is likely to deform under the effect of the high temperature and high pressure of the gases flowing through said valve, with the consequence of the creation of leakage passages for said gases and the possible prevention of said flap from rotating. The bulge can act as a permanent support for the central part of the gasket, remaining in contact with the solid portion of the gasket, notably throughout the pivoting of the valve in order to pass from a closed position to an open position, or vice versa. This bulge can act as a contact stop intended to prevent any deformation of the solid portion of the gasket, preferably at any time during the rotation of the flap. Such a bulge makes it possible to preserve the geometric integrity of the gasket and thus to ensure proper operation of the valve and also proper sealing thereof. This bulge may be formed by an added part that is fastened to the flap, or may form with said flap one and the same part manufactured in one operation.

The bulge may be in contact with the solid portion of the gasket when the flap is in the closed position and/or when the flap is in the open position.

Thus:
in the closed position of the flap, the first part of the flap can close off the opening in the gasket while the bulge is in contact with the solid portion of the gasket, and
in the open position of the flap, the first part of the flap does not close off the opening in the gasket while the bulge can be in contact with the solid portion of the gasket.

The bulge may have the right dimensions to remain in contact with the solid portion of the gasket without making the flap heavier or larger.

According to a variant embodiment, the bulge is deformable so as to ensure close contact with the gasket. The contact between the bulge and the solid portion of the gasket may be homogeneous and uniform throughout the rotation of the flap, this meaning that said bulge does not move toward or away from said solid portion during the rotational movement of the flap. When the flap pivots, the bulge also pivots, preferably by staying in contact with the region of the solid portion of the gasket that is most likely to deform.

The flap may comprise a second part that is separated from the first part by the pin of the flap, said second part being flush with the solid portion when the flap is in a closed position, the bulge being positioned between the second part of the flap and the pin of the flap.

Advantageously, the bulge has a longitudinal axis parallel to the rotary pin.

The bulge can protrude toward the second part of the flap, and said bulge can form a space with said second part. The flap can be represented schematically by two aligned parts and a lever arm carrying a rotary pin that is offset with respect to said parts. The bulge may be similar to a boss extending along the rotary pin, being inserted between said pin and the second part of the flap. The space formed between the bulge and the second part of the flap is dedicated to the insertion of the solid portion of the gasket.

Preferably, the cross section of the bulge is delimited by a rectilinear segment and a curved segment, the two ends of which join the two ends of said rectilinear segment. The rectilinear segment corresponds to the base of the bulge by way of which said bulge is on the flap, and the rounded segment corresponds to the outer surface of the bulge, which protrudes from said flap.

According to a preferred embodiment of a valve according to the invention, the bulge is in the form of a half cylinder. This is the particular case in which the curved segment delimits a semicircle, that is to say that the bulge is rounded.

Preferably, the flap is positioned in the valve such that, in cross section, the curved segment of the bulge is in contact with the solid portion of the gasket, a rotation of the flap about its pin causing a relative movement of the bulge with respect to said solid portion of the gasket, while keeping said solid portion in contact with said curved segment of the bulge. In this way, the bulge permanently supports the solid portion of the gasket throughout the rotation of the flap.

Advantageously, the bulge extends over at least half the width of the flap, which is its dimension taken along the rotary pin. This bulge must be able to carry out its function of supporting the solid portion of the gasket, while remaining as small as possible.

Advantageously, the region of the solid portion of the gasket which is in contact with the bulge is a region of said portion which borders the opening in said gasket. Specifically, the region of the solid portion of the gasket which is most subject to deformation is the region which borders the opening in said gasket. The bulge is positioned within said flap in order to support this sensitive region.

Preferably, the two parts of the flap are flat and in continuity of one another, the first part of the flap being in contact with one face of the gasket in order to close off the opening, and the second part of said flap being flush with the opposite face of said gasket at the solid portion thereof.

According to another preferred embodiment of a valve according to the invention, the bulge comprises at least two parts that are aligned along the rotary pin of the flap. Specifically, it is not necessary for the bulge to be continuous. The bulge may be evenly distributed on the flap so as to effectively support the solid portion of the gasket.

Throughout the preceding text, the gasket may be flat, that is to say that the opposite faces of the gasket may each belong exclusively to a given plane.

In a variant, only a part of the gasket may be flat.

A second subject of the invention is a flap for producing a valve according to the invention.

The valves according to the invention have the advantage of being effective in terms of operation, preventing the deformation of the gasket in a simple and appropriate manner without notably requiring a fundamental redesign of their body. Said valves moreover have the advantage of remaining at a constant size with respect to pre-existing valves, since they do not require any addition of additional parts to ensure proper operation thereof. Finally, the valves according to the invention have the advantage of having a degree of modularity, since the bulge can have an appropriate size and geometry, depending on the internal design of said valves and on the degree of stress which could be brought about by the gases present in these valves.

A detailed description of a preferred embodiment of a valve according to the invention is given in the following text with reference to the appended drawings, in which:

FIG. 1 is a line drawing of a deformed prior art gasket,

FIG. 2 is a partial view of a flap and a gasket of a valve according to the invention. In this view, the gasket appears transparent in order to illustrate its arrangement with the flap,

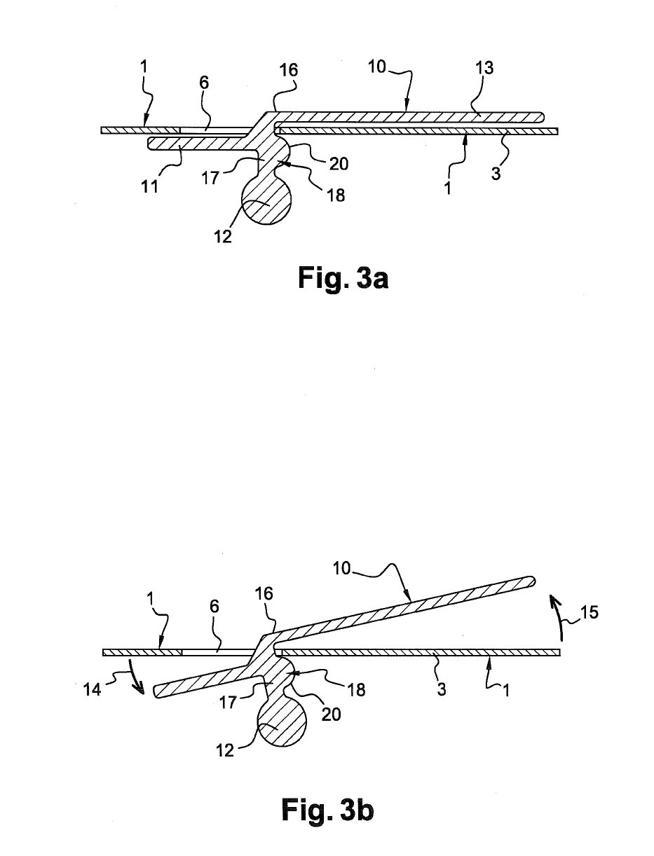

FIG. 3a is a schematic cross-sectional view of a gasket and a flap according to the invention, said flap being in a closed position, and

FIG. 3b is a schematic cross-sectional view of a gasket and a flap according to the invention, said flap being in an open position.

An engine control valve according to the invention can be for example an EGR (Exhaust Gas Recirculation) valve that regulates the flow rate of the gases through a loop connecting an exhaust circuit to an air intake circuit of a vehicle combustion engine.

With reference to FIG. 1, a prior art gasket 1 is made of rigid stainless steel and is inserted at its peripheral edge 2 between two cast elements of the body of said valve 1. The two cast elements are made for example of aluminum. In a variant, one of the cast elements may be made of aluminum while the other cast element is made of cast iron or stainless steel. This peripheral edge 2 thus has a number of orifices 5 that are intended to be passed through by screws so to fasten the gasket 1 between said cast elements. This gasket 1 is flat, having a substantially rectangular shape with a small thickness, and has a solid portion 3 and a passage opening 6 for the gases.

With reference to FIGS. 2, 3a and 3b, a valve according to one exemplary embodiment of the invention comprises an internal duct and functions with a flap 10 that is rotationally mobile between a completely open position, in which it allows the gases to pass through the duct at a maximum flow rate, and a closed position in which it closes off said duct entirely. The flap 10 is rectangular overall and has a first rectangular part 11 and a second rectangular part 13 which are located on either side of a rotary pin 12, said parts 11,13 being flat, in perfect continuity of one another, and being fastened rigidly together. More precisely, the first part 11 and the second part 13 are joined together at an interface plane 16, said flap 10 being provided with a lever arm 17 that starts at said interface plane 16 and is ended by the rotary pin 12. This lever arm 17 is approximately perpendicular to the plane of the flap 10 formed by the first 11 and second 13 parts. It should be clarified that the gasket shown in FIG. 2 is deliberately transparent, even if this is not a physical reality since it consists generally but not necessarily of stainless steel, so as to show its position with respect to the flap 10.

With reference to FIG. 3a, the flap 10 described is mounted so as to rotate in the valve such that in the closed position, the first part 11 of the flap 10 closes off the opening 6 by coming into contact with one face of said gasket 1, and such that the second part 13 of the flap 10 is flush with the opposite face of said gasket 1 in the region of the solid portion 3. The rotary pin 12 of the flap 10 is positioned perpendicularly to the opening 6 in the gasket 1 in the region of said opening 6 that is closest to the solid region 3 of the gasket 1. With reference to FIG. 3b, when the flap 10 opens to allow the gases to pass through, the two parts 11, 13 pivot simultaneously in the direction indicated by the two arrows 14, 15 so as to move away from the face of the gasket 1 against which they were bearing or flush. In this configuration, the first part 11 of the flap 10 opens the opening 6 in the gasket 1 so as to allow the gases to flow through the duct. It should be noted that the rotation of the flap 10 is controlled and that it can be fixed in a multiplicity of intermediate positions between the closed position and the completely open position.

With reference to FIG. 1, the gasket 1 of a valve according to the described exemplary embodiment of the invention is made in one piece and has such an extent as to be able to cover the four peripheral edges of the flap 10. When this gasket 1 is not supported, it has a structurally weak central region which is likely to deform under the combined effect of the high pressure and high temperature of the gases. Specifically, since the gasket 1 is fastened at its periphery 2, only its central part, the movement of which is not restricted, can be subjected to the effects of thermal expansion. This deformation can cause the gasket 1 to warp, creating hollows 4 in the solid part 3 bordering the opening 6. However, a deformed gasket 1 having hollows 4 can impede the rotary mechanism of the flap 10 in the valve, by bearing against said flap 10 and preventing the rotation thereof.

With reference to FIGS. 2, 3a and 3b, the flap 10 of the valve according to the described example makes it possible to prevent deformation of this gasket 1 by being provided with an elongate bulge 18 located on the lever arm 17 of the flap 10 such that its longitudinal axis extends parallel to the rotary pin 12 of the flap 10. This bulge 18 is positioned between the second part 13 of the flap 10 and the rotary pin 12, and protrudes from the lever arm 17 toward the second part 13 of the flap 10. This bulge 18 forms with the second part 13 of the flap 10 a free space intended to be taken up by the solid portion 3 of the gasket 1. The cross section of this bulge 18 has a rectilinear segment 19 and a curved segment 20, the two ends of which join the two ends of said rectilinear segment 19. The rectilinear segment 19 corresponds to the base of the bulge 18 by way of which said bulge 18 is located on the lever arm 17, and the rounded segment 20 corresponds to the outer surface of the rounded part of the bulge 18, which protrudes from said lever arm 17 parallel to the second part 13 of the flap.

With reference to FIG. 3a, the bulge 18 is positioned on the lever arm 17 and is dimensioned such that it can support the region of the solid portion 3 of the gasket 1, which borders the opening 6 in said gasket 1. More precisely, it is the end of the solid portion 3 of the gasket 1 delimiting the opening 6 which comes into contact with the rounded outer surface 20 of the bulge 18.

With reference to FIG. 3b, when the flap 10 pivots about its rotary pin 12 in the direction indicated by the two arrows 14, 15 in order to open, the bulge 18 also pivots, but remains in contact with the solid portion 3 of the gasket 1. Specifically, the rounded part 20 of the bulge 18 according to the example described is designed to allow homogeneous and constant contact with the solid portion 3 of the gasket 1 throughout the rotational movement of the flap 10. In other words, the bulge 18 shown does not move toward or away from the solid portion 3 of the gasket 1 during the rotation of the flap 10. In this way, the bulge 18 on the flap 10 shown acts as a supporting stop for the solid portion 3 of the gasket 1 during rotational movements of the flap 10 in order to pass from a closed position to an open position, and vice versa. This bulge 18 prevents the gasket 1 from deforming by thermal expansion and helps to maintain satisfactory operating conditions of the valve, even in the presence of hot gases under pressure.

1. An engine control valve having a body that delimits an internal duct and comprising:
a flap mounted in a pivoting manner by way of a pin of the flap, the flap comprising a first part and being able to pivot between an open position allowing gas to pass through the duct and a closed position in which the flap comes into contact with a gasket secured to the body of the valve,
said gasket having an external contour that externally surrounds the external contour of the flap, said gasket comprising an opening and a solid portion, said first part closing off the opening in the gasket when the flap is in a closed position, and the flap comprising a bulge separate from the first part of the valve and positioned so as to remain in contact with the solid portion of the gasket when the flap pivots between an open position and a closed position or vice versa.

2. The valve as claimed in claim 1, wherein the flap comprises a second part that is separated from the first part by the pin of the flap, said second part being flush with the solid portion when the flap is in a closed position, the bulge being positioned between the second part of the flap and the pin of the flap.

3. The valve as claimed in claim 1, wherein the bulge has a longitudinal axis parallel to the rotary pin.

4. The valve as claimed in claim 2, wherein the bulge protrudes toward the second part of the flap, and said bulge forms a space with said second part.

5. The valve as claimed in claim 3, wherein the longitudinal axis of the bulge is parallel to the rotary pin, and the cross section of said bulge is delimited by a rectilinear segment and a curved segment, the two ends of which join the two ends of said rectilinear segment.

6. The valve as claimed in claim 5, wherein the bulge is in the form of a half cylinder.

7. The valve as claimed in claim 5, wherein the flap is positioned in the valve such that, in cross section, the curved segment of the bulge is in contact with the solid portion of the gasket, a rotation of the flap about its pin causing a relative movement of the bulge with respect to said solid portion of the gasket, while keeping said solid portion in contact with said curved segment.

8. The valve as claimed in claim 3, wherein the bulge extends over at least half the width of the flap, which is its dimension taken along the rotary pin.

9. The valve as claimed in claim 1, wherein the region of the solid portion of the gasket which is in contact with the bulge is a region of said portion which borders the opening in said gasket.

10. The valve as claimed in claim 2, wherein the two parts of the flap are flat and in continuity of one another, the first part of the flap being in contact with one face of the gasket in order to close off the opening, and the second part of said flap being flush with the opposite face of said gasket at the solid portion thereof.

11. The valve as claimed in claim 1, wherein the bulge comprises at least two parts that are aligned along the rotary pin of the flap.

12. The valve as claimed in claim 1, wherein the gasket is flat.
